(19) United States
(12) Patent Application Publication
(10) Pub. No.: US 2025/0066696 A1
(43) Pub. Date: Feb. 27, 2025

(54) A STABLE BLEACH COMPOSITION

(71) Applicant: Conopco Inc., d/b/a UNILEVER, Englewood Cliffs, NJ (US)

(72) Inventors: Shanthi Appavoo, Wageningen (NL); Samiran Mahapatra, Wageningen (NL); Pintu Paul, Wageningen (NL)

(73) Assignee: Conopco Inc., d/b/a UNILEVER, Englewood Cliffs, NJ (US)

(21) Appl. No.: 18/576,124

(22) PCT Filed: Jul. 25, 2022
(86) PCT No.: PCT/EP2022/070726

§ 371 Date: Jan. 3, 2024

(30) Foreign Application Priority Data
Aug. 4, 2021 (EP) 21189591.7

(51) Int. Cl. C11D 3/39; C11D 1/62; C11D 1/90; C11D 1/94; C11D 3/20; C11D 3/37

(52) U.S. Cl. CPC C11D 3/394; C11D 1/94; C11D 3/2086; C11D 3/3707; C11D 3/3715; C11D 3/3753; C11D 3/3942; C11D 1/62; C11D 1/90

(57) ABSTRACT

The present invention relates to improving the stability of a peroxide containing bleach composition. It particularly relates to such a composition for hard surface cleaning applications including toilet cleaning as well as for fabric cleaning application. It relates to an antimicrobial composition comprising a peroxide bleaching agent which in the presence of a cationic surfactant and an organic acid is more stable than has been heretofore known. This is achieved by inclusion of a stabilizer which in the present invention is a polyalkylene glycol compound.

### FIELD OF THE INVENTION

The present invention relates to improving the stability of a peroxide containing bleach composition. It particularly relates to such a composition for hard surface cleaning applications including toilet cleaning as well as for fabric cleaning applications.

### BACKGROUND OF THE INVENTION

Disinfecting cleaning compositions are of great benefit to individuals, since proper use generally may reduce the number of germs and pathogens the individual is exposed to. Such compositions may for instance play an important role in reducing the occurrence and spread of infectious diseases. Disinfecting compositions containing chlorine-based bleaches are known. Such compositions are sometimes considered to be rather harsh as it may exhibit undesirable side effects, such as corrosion, malodour (like a chlorine smell) and skin irritation or skin-sensitising effects when it comes in contact with a person's skin or mucous membrane. Therefore, many consumers prefer using compositions containing milder bleaches e.g. peroxide compounds.

Such bleach compositions are used for cleaning hard surfaces e.g. cleaning of floors, table tops, kitchen surfaces and utensils. They are also used for cleaning bathrooms and toilets. These composition may also include certain antimicrobial agents. An antimicrobial agent like a cationic surfactant is preferred as it not only delivers the desired antimicrobial efficacy but also has surfactant action which helps in cleaning the surfaces to be free of dirt and oils. Such compositions also include certain organic acids which are known to boost antimicrobial efficacy. The present applicants have filed patents published as EP2780438B1 and EP2773739B1 where such a combination along with certain other ingredients are claimed to deliver improved antimicrobial efficacy.

Washing fabrics, also known as laundering or simply as laundry, makes up one of the main chores that people undertake routinely. For this, people have been relying on detergent compositions that are widely available. During day-to-day usage of fabrics, particles that may be present in the air e.g. pollen grains, dust and dirt tend to settle on a fabric. In addition, germs or microbes e.g. bacteria, fungi, spores and viruses, that are present in the air, also tend to settle on a fabric just like they tend to settle on other surfaces e.g. floors. These microbes tend to thrive when they come in to contact with substances e.g. sweat and sebum. As a result, microbial growth and/or microbial secretions, lead to problems e.g. leaving behind stains or spots which tend to affect appearance of a fabric, creation of unhygienic conditions due to thriving germs; and at times, generation of malodour. It is for reasons like these that washing of fabric becomes necessary to maintain the fabric in good condition so that it can be re-worn. Surfactants contained in a detergent composition, are primarily used for the cleaning function. To an extent, surfactants alone or along with other ingredients that may be present in a detergent composition, are able to remove germs that may be adhering to a fabric. To provide further removal of germs, antimicrobials agents like hydrogen peroxide and/or cationic surfactants may be added to these compositions.

One of the problems which the present inventors have noticed when peroxide bleaching agents are included in a composition comprising a cationic surfactant and an organic acid is that the composition is unstable on storage. Certain gases are evolved when such liquid compositions are packed e.g. in a plastic container such that the container starts to bloat after some time. The problem can be solved by providing certain vents in the container but such a solution makes the packaging complex and expensive to manufacture.

Other solutions for stabilizing peroxide containing compositions have been proposed. US2019/0045789 (Microbio Solutions) discloses an antimicrobial composition comprising lauric arginate ethyl ester (LAE) and hydrogen peroxide and the use of this composition for disinfecting and sanitizing different types of surfaces such as food products, human skin and hard surface as well as method of stabilizing the composition by including a sequestering agent (citric salt and/or phosphate salt). The above publication does not specifically provide for a specific solution to the bloating problem.

The present inventors with their deep understanding of the chemistry of such multi-ingredient compositions and extensive experiments hit upon a solution to the problem. They found that inclusion of polyalkylene glycols improved the stability of such compositions thereby mitigating the problem of bloating of the packages.

It is an object of the present invention to provide for an antimicrobial composition comprising a peroxide bleaching agent which in the presence of a cationic surfactant and an organic acid is more stable than has been heretofore known.

### SUMMARY OF THE INVENTION

According to the first aspect of the present invention there is provided a bleach composition comprising
(i) 0.1 to 4 wt % peroxide
(ii) 0.1 to 3 wt % one or more cationic surfactant selected from alkyl dimethyl benzylammonium chloride (ADBAC),
alkyl diethyl benzylammonium chloride (ADEBAC), bis (C8-C18) alkyl di methyl quaternary ammonium chloride preferably didecyl dimethyl ammonium chloride (DDAC), cetyl trimethyl ammonium chloride (CTAC), cetyl pyridinium chloride (CPC), cetrimonium bromide, benzethonium chloride (BZE); and dimethyldioctadecylammonium chloride;
(iii) 0.1 to 5 wt % of an organic acid or salts thereof; and
(iv) 0.1 to 2 wt % of a stabilizer which is a polyalkylene glycol.

According to another aspect of the present invention there is provided a method of stabilizing a peroxide compound in a composition comprising
(i) 0.1 to 4 wt % of peroxide;
(ii) 0.1 to 3 wt % of one or more cationic surfactant selected from alkyl dimethyl benzylammonium chloride (ADBAC), alkyl diethyl benzylammonium chloride (ADEBAC), bis (C8-C18) alkyl di methyl quaternary ammonium chloride preferably didecyl dimethyl ammonium chloride (DDAC), cetyl trimethyl ammonium chloride (CTAC), cetyl pyridinium chloride (CPC), cetrimonium bromide, benzethonium chloride (BZE); and dimethyldioctadecylammonium chloride; and
(iii) 0.1 to 5 wt % of an organic acid,
comprising the step of including 0.1 to 2 wt % of a stabilizer selected from a polyalkylene glycol therein.

### DETAILED DESCRIPTION OF THE INVENTION

For the avoidance of doubt, any feature of one aspect of the present invention may be utilised in any other aspect of the invention. The word “comprising” is intended to mean “including” but not necessarily “consisting of” or “composed of”. Thus, the term “comprising” is meant not to be limiting to any subsequently stated elements, but rather to optionally also encompass non-specified elements of major or minor functional importance. In other words, the listed steps or options need not be exhaustive. Whenever the words “including” or “having” are used, these terms are meant to be equivalent to “comprising” as defined above. It is noted that the examples given in the description below are intended to clarify the invention and are not intended to limit the invention to those examples per se. Except in the examples, or where otherwise explicitly indicated, all numbers in this description indicating amounts of material or conditions of reaction, physical properties of materials and/or use are to be understood as modified by the word “about”. Unless specified otherwise, numerical ranges expressed in the format “x to y” are understood to include x and y. When for a specific feature multiple preferred ranges are described in the format “x to y”, it is understood that all ranges combining the different endpoints are also contemplated. Unless specified otherwise, amounts as used herein are expressed in percentage by weight based on total weight of the composition and is abbreviated as “wt %”.

Throughout this description, the term disinfection refers to reduction of the number of viable microorganisms in a given medium or on a given surface by physical or chemical means. Typically, disinfection involves the destruction or inactivation of said microorganisms. Both animate and inanimate media and surfaces are contemplated.

The term “antimicrobial” refers to a compound capable of killing, inhibiting the growth of or controlling the growth of microorganisms at a locus; antimicrobials include bactericides, fungicides and algaecides. The term “microorganism” includes, for example, fungi (such as yeast and mould), bacteria and algae.

The compositions of the present invention are preferred for non-therapeutic use, and more particularly preferred for use in cleaning surfaces, preferably wherein the surface is a hard surface and more preferably for use in cleaning applications such as cleaning kitchen, bathroom, toilet and floor surfaces. They may also be used for cleaning fabrics.

The composition comprises a peroxide compound. Preferably, the peroxide compound is one or more selected from the group consisting of hydrogen peroxide (H₂O₂), peracetic acid, barium peroxide (BaO₂), sodium peroxide (Na₂O₂), tert-butylhydroperoxide, and potassium peroxydisulfate. More preferably, the peroxide selected is hydrogen peroxide. Alternatively, one or more sources of hydrogen peroxide are selected from sodium percarbonate, sodium perborate, sodium persilicate, and sodium persulphate; which release hydrogen peroxide when contacted with water, may also be used preferably in combination with an activator e.g. tetra-acetylethylenediamine (TAED).

The composition preferably comprises from 0.5 to 4 wt %, more preferably from 1 to 4 wt %, further more preferably from 1 to 3 wt %, even more preferably from 1 to 2.5 wt % of the peroxide compound.

The composition comprises a cationic surfactant. Preferably, the cationic surfactant is a quaternary ammonium surfactant, preferably the quaternary ammonium surfactant is selected from one or more of alkyl dimethyl benzylammonium chloride (ADBAC) which is also known as benzalkonium chloride (BKC), bis (C8-C18) alkyl di methyl quaternary ammonium chloride preferably didecyl dimethyl ammonium chloride (DDAC), cetyl trimethyl ammonium chloride (CTAC), cetyl pyridinium chloride (CPC), cetrimonium bromide, benzethonium chloride (BZE); and dimethyldioctadecylammonium chloride. Preferred aspect of the invention provides for the cationic surfactant to be chosen from one or more of BKC or DDAC, preferably BKC.

The quaternary ammonium surfactants mentioned above, are available as a single quaternary ammonium compound, as well as mixtures of two or more different quaternary ammonium compounds e.g. under trademarks BARDAC™, BARQUAT® and HYAMINE® (all by Lonza); and BTC® (by Stepan). Quaternary ammonium compounds available as a single quaternary ammonium compound include didecyl dimethyl ammonium chloride (available as BARDAC™ 2250 R and BTC® 1010, both 50% active; and BARDAC™ 2280 R and BTC® 1010-80, both 80% active), alkyl dimethyl benzyl ammonium chloride (available as BARQUAT® MB-50, BARQUAT® MX-50, BARQUAT® OJ-50, HYAMINE® 3500, BTC® 50, BTC® 50E, BTC® 65, BTC® 776, BTC® 824, BTC® 835; each 50% active; and the same is available as BARQUAT® MB-80, BARQUAT® MX-80, HYAMINE® 3500-80, BTC® 8248, BTC® 8358; each 80% active

The composition preferably comprises 0.1 to 3 wt %, more preferably 0.3 to 2 wt % cationic surfactant.

The composition of the invention includes an organic acid or salt thereof. The organic acid is preferably a carboxylic acid. Any carboxylic acid may be used but it is preferred that the carboxylic acid has a pKa value in the range of 1 to 5.5.

Examples of one or more carboxylic acid that may be used in the present invention include citric acid (pKa=3.1), lactic acid (pka=3.86), acetic acid (pKa=4.76), malonic acid (pKa=2.85), adipic acid (pKa=4.43), glutaric acid (pKa=3.76), glycolic acid (pKa=3.83) and maleic acid (pKa=1.9), succinic acid (pKa=4.2), malic acid (pKa=3.4), tartaric acid (for L+pKa=2.89; and for meso pKa=3.22), hexanoic acid (pKa=4.88), cyclohexanoic acid (pKa=4.82), heptanoic acid (pKa=4.8), octanoic acid (pKa=4.89), 4-methyl octanoic acid (pKa=5.23), nonanoic acid (pKa=4.95), decanoic acid (pKa=4.9), benzoic acid (pKa=4.2) and 4-methoxy benzoic acid (pKa=4.37).

Preferred organic acid for use in the present invention are one or more of lactic, glycolic, tartatic, malic and citric acid. The most preferred acid is citric acid. The organic acid may also be present in the salt form. Alkali metal or alkaline earth metal salts are preferred, more preferably alkali metal salts of which sodium salt is most preferred. The composition comprises 0.1 to 5%, preferably 0.5 to 3 wt % of organic acid or salt thereof.

The stabiliser in the present invention is a polyalkylene glycol. Preferred polyalkylene glycol is one having a molecular weight in the range of 200 to 600 Da. Preferred stabilizer is polyethylene glycol (PEG). Preferred PEG is one having molecular weight in the range of 200 to 600 Da. Most preferred PEG is PEG 200. The stabilizer is included in 0.1 to 2%, preferably 0.5 to 1.5% by weight of the composition.

The composition as per the invention preferably comprises an additional surfactant which is an amphoteric surfactant. Amphoteric surfactants which may be used include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms preferably selected from C12, C14, C16, C18 and C18:1, the term “alkyl” being used to include the alkyl portion of higher acyl radicals. Preferred amphoteric surfactant, when included, is selected from a C8-C18 alkyl amine n-oxide (which is broadly referred to an amine oxide) or a betaine of which the betaine is more preferred. When an amine oxide is included it is preferably lauramine oxide. When a betaine is include it is preferably amidopropyl betaine of which cocoamidopropyl betaine is most preferred. When included the amphoteric surfactant is present in an amount ranging from 0.5 to 2%, preferably 0.5 to 1% by weight of the composition.

To further enhance stability, the composition may comprise an additional stabilizer. The additional stabiliser is preferably a non-ionic polymer. Suitable non-ionic polymers are selected from one or more of a polyvinyl alcohol (PVA), polyaspartic acid or salt thereof, or polyvinyl pyrrolidone polymer. Of these polyvinyl alcohol or polyaspartic acid are more preferred.

The structure of polyvinyl alcohol (partially hydrolyzed) is given below:

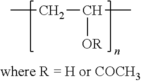

It is also known as polyvinyl acetate (If R═COCH₃). It can be sourced from Kurary India Pvt Ltd.

The structure of polyaspartic acid is given below:

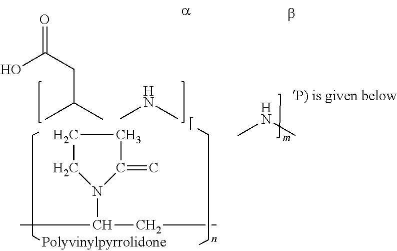

The additional stabilizer when included, is present in 0.02 to 2%, preferably 0.05 to 1.5% by weight of the composition.

When the composition is formulated for use in a laundry applications, it preferably comprises from 5 to 20 wt % non-ionic surfactant based on the total weight of composition. A preferred class of nonionic surfactant for use in the invention includes aliphatic C8 to C18, more preferably C12 to C15 primary linear alcohol ethoxylates with an average of from 3 to 20, more preferably from 5 to 10 moles of ethylene oxide per mole of alcohol. A preferred non-ionic surfactant is the C16/18 alcohol ethoxylate.

The composition is generally in liquid form. It contains high amount of water. Water is generally present in 84 to 98.5%, preferably 90 to 95% by weight of the composition.

Preferably, the composition further comprises one or more sequestrants. A preferred sequestrant is a phosphonic acid or a salt thereof. The phosphonic acid (or salt thereof) sequestrant is preferably selected from the group consisting of 1-Hydroxyethylidene-1,1-diphosphonic acid (HEDP; commercially available as Dequest@ 2010), Diethylenetriaminepenta(methylenephosphonic acid) (DTPMP; commercially available as Dequest® 2066), Hexamethylenediaminetetra(methylenephosphonic acid) (HDTMP), Aminotris(methylenephosphonic acid) (ATMP), Ethylenediaminetetra(methylenephosphonic acid) (EDTMP), Tetramethylenediaminetetra(methylenephosphonic acid) (TDTMP); and Phosphonobutanetricarboxylic acid (PBTC). Preferably, the sequestrant selected is HEDP.

Preferably, the composition comprises sequestrant that may be present in an amount from 0.01 to 5 wt %, more preferably from 0.05 to 4 wt %, even more preferably from 0.1 to 2.5 wt %.

The composition may optionally comprise other ingredients, such as fragrance and/or colour.

The composition preferably has a pH in the range of 2 to 5 preferably in the range of 2.5 to 4. The pH of the liquid compositions was measured using Orion Versa star (Thermo scientific) pH meter.

More preferably, the composition as viscosity in the range from 1 to a maximum of 10 mPa·s @ 20 s⁻¹. Viscosity of the composition is measured using an AR 1000 Rheometer (TA instruments) using a 4 cm, 2° cone-plate geometry at 25° C. Preferably, the composition has viscosity less than 10 mPa·s @ 20 s⁻¹.

The composition of the invention is preferably used for home care applications. A “home care product” is a product for the treatment, cleaning, caring or conditioning of the home or any of its contents. The foregoing includes, but is not limited to, compositions, products, or combinations thereof relating to or having use or application in the treatment, cleaning, cleansing, caring or conditioning of surfaces, furniture and atmosphere of the home and household contents, such as clothes, fabrics and/or cloth fibres and the manufacture of all of the foregoing products.

Preferably, the composition used in the present invention is used to clean a hard surface, more preferably wherein the hard surface is a kitchen, bathroom or floor surface. Typically, such hard surfaces are surfaces that require frequent cleaning and preferably also sanitisation and/or disinfection. Such surfaces may be found in many household or industrial environments, and may include kitchen and bathroom surfaces, tabletops, floors, walls, windows, utensils, cutlery, and crockery. Such surfaces may be made from many different materials, including for instance plastics, wood, metal, ceramics, glass, concrete, marble, and painted surfaces. The composition may be applied to the surface by any suitable means known to the skilled person. For instance, a suitable means may be pouring, dropping, spraying or wiping in case of liquid compositions.

The composition may be used as is, i.e. neat, preferably the composition is diluted with water before use. More preferably, the composition is diluted before use. For example, if applied in a diluted form, the composition is diluted with water preferably in a ratio 1:1000, more preferably 1:500, even more preferably 1:200 and further more preferably 1:100 which is substantially more diluted than a typical household cleaning composition e.g. a toilet cleaning composition, which tend to have dilutions e.g. 1:40 when used.

Another aspect of the present invention relates to a method of cleaning and disinfecting a hard surface comprising contacting the surface with the composition of the invention preferably diluted with water in a weight ratio in the range of 1:10 to 1:1000, preferably 1:30 to 1:500 and most preferably from 1:30 to 1:100.

In most hard surface cleaning application, the diluted solution is applied on to the desired surface by using a brush or a mop and allowing it to dry. In certain vertical surfaces, it may be sprayed on using a hand held spray pump. In certain cases, the compositions after it is applied on to the desired surface, may be wiped off to a substantially dry condition using a dry cloth or wipe. In toilet cleaning applications, the composition is generally applied on to the toilet bowl, allowed to stay thereon for a few minutes, and then the toilet is flushed.

Another preferred embodiment of the invention relates to compositions according to the invention for use as or incorporation in industrial and/or institutional products. More preferably, this embodiment of the invention relates to a composition according to the invention which is an industrial and/or an institutional product. Industrial and institutional products are for example products being marketed under professional brands, with non-limiting examples being products for industrial, institutional, janitorial, and medical cleaning, cleaning-in-place, food services, veterinary, and agricultural products.

In another aspect, the present invention relates to a method of cleaning and disinfecting a fabric by (a) contacting the fabric with the composition of the first aspect for 5 to 60 minutes, (b) rinsing it with water; and (c) drying the fabric.

Typically, a fabric is washed by contacting it with a detergent composition either in neat or diluted form, rinsing the fabric one or more times e.g. two or three times with water; and finally, drying it. In the washing step, a fabric is cleaned by mechanically agitating it using hands and/or by using suitable cleaning means e.g. a brush, in so-called hand-wash method. Alternatively, in so-called machine-wash method, a fabric is cleaned by mechanically agitations carried out by a machine. In either case, a step of soaking a fabric, in a neat or diluted detergent composition, may be carried out for a desired duration e.g. 30 to 60 minutes. The step of drying may also be carried out by using machines; or simply by exposing the fabric to air.

The invention shall now be exemplified by the following non-limiting examples.

### EXAMPLES

### Examples A-C, 1-3: Stability of Composition as Per the Invention as Compared to Those Outside the Invention

The compositions as shown in Table-1 were prepared.

TABLE 1

| Ingredients | wt % |
|---|---|
| BKC | 0.9 |
| Cocoamido propyl | 0.85 |
| betaine | |
| Hydrogen peroxide | 2.0 |
| Lactic acid | 1.5 |
| Stabilizer | As in table −2 |
| | below |
| Water | To 100 |

TABLE 2

| Example | Wt % and Stabilizer |
|---|---|
| A | 0.08% Baypure DS |
| | 100/40 |
| B | 0.25% PVA + 0.08% |
| | Baypure DS100/40 |
| C | 0.25% PVA |
| 1 | 1% PEG200 |
| 2 | 1% PEG200 + 0.08% |
| | Baypure DS 100/40 |
| 3 | 1% PEG200 + 0.25% |
| | PVA |

### In the Above Table

### Baypure DS 100/40 is Polyaspartic Acid

The stability of the above compositions was studied using the following procedure: The bulging behaviour of the containers in which the composition was stored was monitored over a course of 8 weeks. Samples were stored at 25° C. and 37° C. The amount of bulging was graded as Good, Poor or V. Poor as visually observed, over the storage period, with Good indicating no bulging, Poor indicating some bulging and V. Poor indicating significant bulging.

The observations are summarized in table 3 below.

TABLE 3

| Exam- | 2 weeks | 2 weeks | 4 weeks | 4 week | 8 weeks | 8 weeks |
|---|---|---|---|---|---|---|
| ple | 25° C. | 37° C. | 25° C. | 37° C. | 25° C. | 37° C. |
| A | Good | Poor | Good | Poor | Good | Very poor |
| B | Good | Very poor | Good | Very Poor | Good | Good |
| C | Good | Good | Good | Very Poor | Good | Very poor |
| 1 | Good | Good | Good | Good | Good | Poor |
| 2 | Good | Good | Good | Good | Good | Good |
| 3 | Good | Good | Good | Good | Good | Good |

The data in the table above indicates that composition of the invention (Examples 1) where polyalkylene glycol is used as the stabilizer is superior to other stabilisers (Examples A to C). Results of Examples 2 and 3 indicate that using a combination of polyalkylene glycol and an additional stabilizer which is a non-ionic polymer provides for further improved stability.

### Example E and F: Use of Monomeric Alkylene Glycol

Compositions as shown in Table 4 below were prepared to check if a monomeric stabilizer (monopropylene glycol) would work.

TABLE 4

| | Example-E | Example-F, |
|---|---|---|
| Ingredients | wt % | wt % |
| BKC | 0.9 | 0.9 |
| Cocoamido propyl | 0.85 | 0.85 |
| betaine | | |
| Hydrogen peroxide | 2.0 | 2.0 |
| PVA | 0.25 | 0.00 |
| Baypure DS 100/40 | — | 0.08 |
| Monopropylene glycol | 1.0 | 1.0 |
| Sodium hydroxide | 0.17 | 0.17 |
| Lactic acid | 1.5 | 1.5 |
| Water | To 100 | To 100 |

Both of the above samples were graded as V. Poor at end of 2 weeks at 37° C. storage.

1. A liquid bleach composition comprising
(i) 0.1 to 4 wt % of a peroxide compound;
(ii) 0.1 to 3 wt % of one or more cationic surfactant selected from
alkyl dimethyl benzylammonium chloride (ADBAC),
alkyl diethyl benzylammonium chloride (ADEBAC). bis (C8-C18) alkyl di methyl quaternary ammonium chloride preferably didecyl dimethyl ammonium chloride (DDAC), cetyl trimethyl ammonium chloride (CTAC), cetyl pyridinium chloride (CPC), cetrimonium bromide, benzethonium chloride (BZE); and dimethyldioctadecylammonium chloride;
(iii) 0.1 to 5 wt % of an organic acid or salt thereof; and
(iv) 0.1 to 2 wt % of a stabilizer selected from a polyalkylene glycol having a molecular weight in the range of 200 to 600 Da; and
(v) water from 84 to 98.5 wt %.

2. The composition as claimed in claim 1 wherein the peroxide is hydrogen peroxide.

3. The composition as claimed in claim 1, additionally comprising an amphoteric surfactant.

4. The composition as claimed in claim 3, wherein the amphoteric surfactant is selected from C8-C18 alkyl amine n-oxide.

5. The composition as claimed in claim 1, wherein the organic acid is selected from one or more of lactic acid, glycolic acid, malic acid, tartaric acid and citric acid.

6. The composition as claimed in claim 1, wherein the polyalkylene glycol is polyethylene glycol (PEG).

7. The composition as claimed in claim 6, wherein the PEG is PEG 200.

8. The composition as claimed in claim 1, comprising an additional stabilizer which is a non-ionic polymer selected from one or more of a polyvinyl alcohol, polyaspartic acid and polyvinyl pyrrolidone.

9. A method of stabilizing a peroxide compound in a liquid composition comprising
(i) 0.1 to 4 wt % a peroxide compound;
(ii) 0.1 to 3 wt % of one or more cationic surfactant selected from alkyl dimethyl benzylammonium chloride (ADBAC), bis (C8-C18) alkyl di methyl quaternary ammonium chloride preferably didecyl dimethyl ammonium chloride (DDAC), cetyl trimethyl ammonium chloride (CTAC), cetyl pyridinium chloride (CPC), cetrimonium bromide, benzethonium chloride (BZE); and dimethyldioctadecylammonium chloride; and
(iii) 0.1 to 5 wt % of an organic acid, and
(iv) water from 84 to 98.5 wt %;
comprising the step of including 0.1 to 2 wt % of a stabilizer which is a polyalkylene glycol having a molecular weight in the range of 200 to 600 Da therein.

10. A method of cleaning and disinfecting a hard surface or a fabric, the method comprising a step of contacting the surface or fabric with a composition as claimed in claim 1.

11. The method of claim 10, wherein the fabric is contacted with the composition for 5 to 60 minutes, then comprising the steps of rinsing it with water; and (c) drying the fabric.

12. The method of claim 10, wherein the composition is diluted with water in a weight ratio in the range of 1:10 to 1:1000.

13. The composition of claim 4, wherein the amphoteric surfactant is lauramine oxide or a betaine.

14. The composition of claim 13, wherein the amphoteric surfactant is cocoaminopropyl betaine.
